(19) United States
(12) Patent Application Publication
(10) Pub. No.: US 2010/0097472 A1
(43) Pub. Date: Apr. 22, 2010

(54) METHOD OF EFFICIENT CAMERA CONTROL AND HAND OVER IN SURVEILLANCE MANAGEMENT

(75) Inventors: Silky Chathukutty, Bangalore (IN); Chaithanya Holla, Bangalore (IN); Jeetendra Kumar Mallireddy, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/255,439

(22) Filed: Oct. 21, 2008

(51) Int. Cl. H04N 7/18

(52) U.S. Cl. 348/159; 348/E07.085

(57) ABSTRACT

A method and system for video surveillance in a system having a plurality of cameras is presented, the method comprising creating a plurality of logical camera groups, each group comprising a list of the cameras, tracking a subject using a current camera, and changing from the current camera to a next camera using a control device, wherein the control device provides the list of cameras in the logical camera group and the next camera is selected from this list. In this method, each camera can be a fixed or a PTZ camera, each PTZ can have a preset view in the logical camera group, the next camera can be a handover camera enabling hand over from a current operator to a next operator, the next operator can be selected from a list on the control device, and control of the current camera can be determine by operator priority.

### CROSS REFERENCE TO RELATED APPLICATION

This application is related to commonly-owned, co-pending U.S. patent application Ser. No. 12/206,071 filed on Sep. 8, 2008, the entire contents and disclosure of which is expressly incorporated by reference as if fully set forth herein.

### FIELD OF THE INVENTION

This invention relates generally to video surveillance in accordance with a security system. In particular, this invention relates to hand over across surveillance cameras and between operators.

### BACKGROUND OF THE INVENTION

To maintain the security of a site and/or a premise, such as a structure, a set of buildings, etc., video surveillance or monitoring can be performed. Typically this involves installing multiple cameras or other surveillance devices throughout the premises. The image obtained by a surveillance camera mounted in the area being monitored and/or secured is generally displayed on a video screen or monitor. During video surveillance, multiple operators view one or more of these monitors or video screens, watching for particular activities, abnormalities and other events. When an event occurs, an operator may have to report it, and the operator may wish to interact and/or collaborate with other operators to determine suspects, objects and/or other items of interests.

One event that often occurs is a requirement to track a person traversing an area of surveillance. To obtain appropriate views and perform this tracking, an operator has to manually switch between video screens displaying images from various cameras. Manual switching between cameras is a cumbersome process in which the operator must perform a series of steps to activate and/or deactivate the appropriate cameras. Hence, to continuously track a person, the current tracking operator has to know not only the camera and its images shown on his monitor, but also neighboring cameras and their preset views. Further, it may be necessary for an operator to know his neighboring operators and their cameras, so that one operator can hand over tracking to another, appropriate operator. This requires intensive operator training and knowledge of the camera setup throughout the site being monitored, making the video surveillance system fully dependent on operator skills.

Accordingly, there is a need for a video surveillance system and method that increases operator efficiency by reducing the multiple-operations required to switch between cameras and their preset views.

### SUMMARY OF THE INVENTION

The present invention advantageously provides easier and efficient means of camera control and operator handover within a site protected by a security system. In the inventive system, each surveillance camera in the security system can be grouped with one or more neighboring cameras. Each camera grouping can be configured with one or more common regions and/or preset views. When an operator is monitoring a person and the person is about to leave the view of camera, the operator can issue a request for handover of control to a neighboring camera by pressing a button on the closed circuit television (CCTV) keyboard or touch screen. When more than one neighboring camera and/or region is configured for handover, a list will be provided for the operator to select from. Handover control can be extended to a second operator if the person being monitored leaves the area of view of the first operator.

The inventive method and system for video surveillance in a system having a plurality of cameras comprises steps of creating a plurality of logical camera groups, each group comprising a list of the cameras, tracking a subject using a current camera, and changing from the current camera to a next camera using a control device, wherein the control device provides the list of cameras in the logical camera group and the next camera is selected from this list. In this inventive method and system, each camera can be a fixed or a PTZ camera, each PTZ can have a preset view in the logical camera group, the next camera can be a handover camera enabling hand over from a current operator to a next operator, the next operator can be selected from a list on the control device, and control of the current camera can be determined by operator priority.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a schematic illustration of an exemplary embodiment of the present invention;

FIG. 2 is a schematic illustration of an embodiment of the present invention in a T-shaped passage;

FIG. 3 is a schematic illustration of an embodiment of the present invention in an L-shaped passage;

FIG. 4 is a schematic illustration of an embodiment of the present invention in a passage having sharp angles;

FIG. 5 is a schematic illustration of another embodiment of the present invention;

FIG. 6 shows an initial screen having logical control groups in an embodiment of the present invention;

FIG. 7 shows a display screen listing cameras in the embodiment shown in FIG. 6;

FIG. 8 shows exemplary handover information in the embodiment shown in FIG. 6;

FIG. 9 shows button setting information in the embodiment shown in FIG. 6;

FIG. 10 shows various control device display screens in the embodiment shown in FIG. 6; and

FIG. 11 is a flow diagram of an embodiment of the present invention.

The foregoing and other objects, aspects, features, and advantages of the invention will become more apparent from the following description and from the claims.

### DETAILED DESCRIPTION OF THE INVENTION

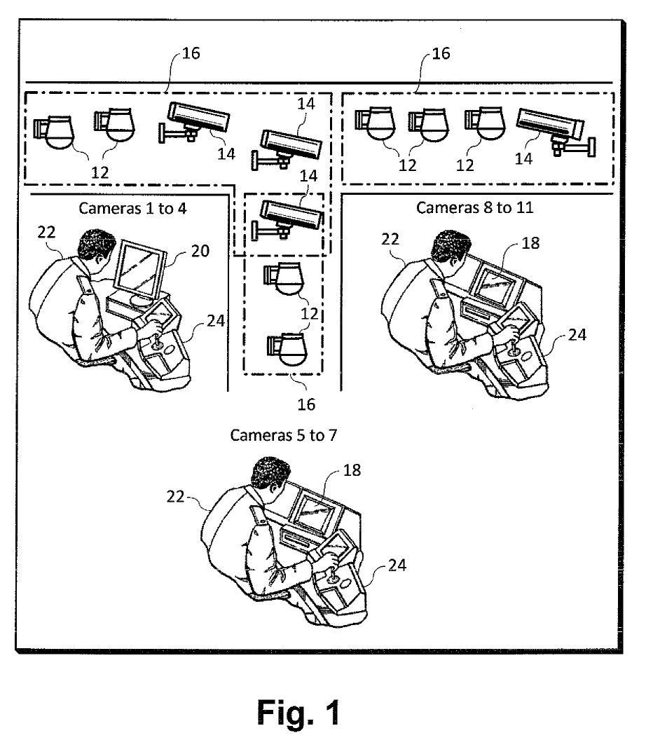

An inventive solution is presented to the need for a video surveillance system and method that increases operator efficiency when switching between cameras and/or between operators. FIG. 1 shows an embodiment of the inventive system 10 comprising surveillance cameras 12, 14 within a surveillance area. The system 10 further comprises logical groupings of the surveillance cameras 12, 14, e.g. logical camera groups 16, in which the cameras 12, 14 are grouped or associated with one or more neighboring cameras 12, 14. Each camera 12, 14 is assigned a camera call-up number. Any types of cameras known in the art can be used, including fixed cameras 12 and/or Pan Tilt Zoom (PTZ) cameras 14. The PTZ camera 14 can be a Speed Dome camera. Each logical camera grouping 16 can be configured to secure or monitor one or more common regions, sites, or physical surveillance areas. A preset view is defined for each PTZ camera 14 in each logical camera group 16.

Each camera 12, 14 creates and displays images on a monitor 18, 20 viewable by a surveillance operator 22. The video surveillance can be performed on any type of monitor, including both analog 18 and digital 20 monitors. Typically, a monitor 18, 20 displays the view from only one camera 12, 14 at a time. The view from a specific camera 12, 14 at any given point in time is known as a “view of interest” or area of surveillance. This view of interest is an area in which an operator 22 feels something relevant, or worth watching, is occurring; for example a view of interest can contain a person or subject being tracked. Optionally, on an analog monitor 18, the view of interest can be displayed with controls available to the operator 22 as he monitors the view.

In one embodiment, cameras 12, 14 can be placed into the logical grouping 16 and controlled using a control device 24 such as a keyboard or a touch screen, for example Ultrakey touch screen by Honeywell International Inc. This control device 24 can be operated by clicking on a button, for example. Each camera 12, 14 can be individually selected and separately added to at least one logical group 16. Options for selection of cameras to be viewed and controlled can be presented on the touch screen 24, and these options can be made available to the operator 22 “on-the-fly”. Further, options for selecting neighboring cameras 12, 14 can be displayed on subsequent or “sub-” screens of the touch screen 24.

In one embodiment, the logical camera groups 16, along with configured layout details, can be stored within the control device 24, e.g. Ultrakey. Camera 12, 14 details, such as IP address, camera call-up number, Ultrakey keyboard ID, serial port and/or IP address of Ultrakey, operator access details, etc., generally can be stored in a database server of the security system application.

Advantageously, the operator 22 at any time can choose between cameras 12, 14 from the logical camera groups 16 of interest to him. Absent these groups 16, an operator 22 would have to remember the call-up numbers of the neighboring cameras and their ordering or placement in the area being monitored. Thus, without the groups 16, an operator 22 would use a trial and error method or would refer to a chart of camera call-up numbers and their locations before selecting the appropriate camera.

The PTZ cameras 14 providing video displays for the monitors 18, 20 can be automatically set to be controlled from an operator's touch screen or control device 24, even when the video display is changed from one PTZ camera 14 to other PTZ cameras 14 within the logical group 16 of the same operator 22. In addition, once the tracked subject leaves the field of view of the tracking operator 22, e.g. Operator 1, he can send a message from his control device 24 to another operator's, e.g. Operator 2, control device 24. This message can be, for example, a “Flashing Text Message” asking Operator 2 to control pre-assigned cameras 12, 14 or “set of commands” that can directly put the video display from the camera of interest on Operator 2's monitor, enabling tracking to continue. Operator 2, in response, can control his camera(s) as Operator 1 was doing for his set of cameras 12, 14, so that Operator 2 can continue tracking the subject of interest. Further, Operator 2 can hand over the control of the camera 12, 14 either back to Operator 1 or to a new operator, e.g. Operator 3, based on the subject's movement.

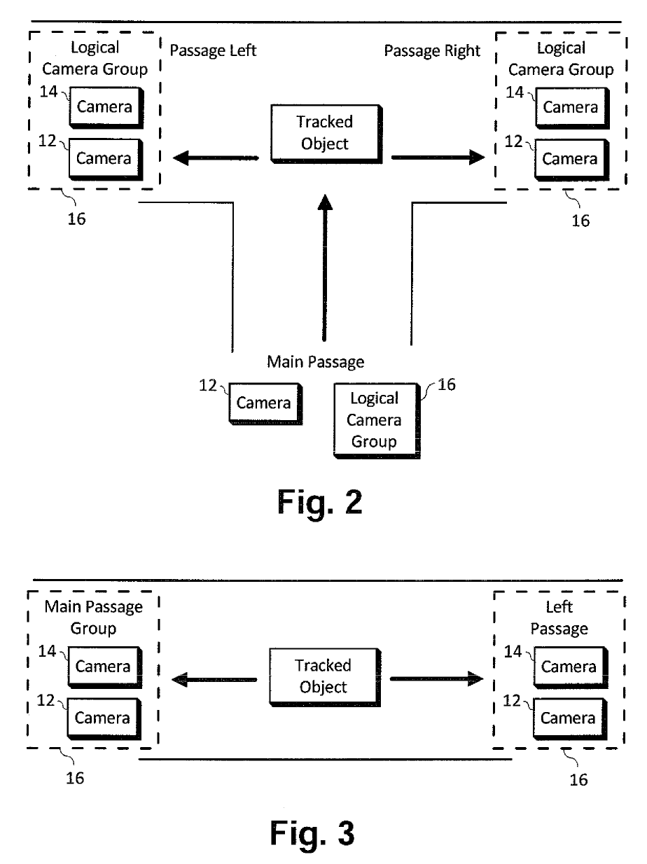

FIGS. 2-4 illustrate tracking or monitoring a subject of interest by one operator 22 using the inventive system 10 in various passage areas. FIG. 2 provides an example of the inventive system 10 in which a passage comes to a T-junction. The logical camera groups 16 group or associate the cameras 12, 14 as “Main Passage”, “Passage Left” and “Passage Right”. An operator 22 tracking a subject or an object selects the desired grouping, e.g., “Main Passage”, and the logically grouped cameras 16 “Passage Left” and “Passage Right” automatically become visible on the next screen or monitor 18, 20, enabling the operator 22 to easily select the appropriate camera and/or view. In addition, selecting a camera from a logical camera group 16, such as “Main Passage”, provides on-the-fly options to access logically grouped neighboring cameras or perform operator handover.

The configuration shown in FIG. 2 consists of “_Main Passage_” grouped with its neighboring cameras “Passage Left” and “Passage Right” including a common preset location for PTZ cameras 14. The subject moving through Main Passage can turn and continue moving towards either Passage Left or Passage Right. In either case, the operator 22 can view and select the neighboring cameras 12, 14 from the logical camera groups 16 using a click of a button on the control device 24. As shown in FIG. 2, the operator 22 can be viewing a camera 12, 14 in the Main Passage, and using his control device 24, he can be provided with an option or choice of selecting the neighboring cameras 12, 14 from the logical camera groups 16, e.g. Passage Left or Passage Right. The view to be selected includes fixed views from the fixed cameras 12 in the group, as well as the configured common preset location for PTZ cameras 14 to which the selected PTZ camera 14 will automatically move if chosen. The view from the selected camera 12, 14 from the chosen logical camera group 16 enables the operator 22 to continue monitoring the subject. Camera control of the selected camera 12, 14 can be in accordance with the operator privileges. The grouping of cameras is flexible and can be tailored depending upon the complexity of design at a site.

FIG. 3 shows an example of the inventive system 10 in which a straight passage comes to an L-junction. The configuration shown in FIG. 3 consists of a Main Passage grouped with its neighboring cameras 12, 14 including a common preset location for PTZ cameras 14 through the straight passage. The subject moving through Main Passage can at anytime turn back and move towards a camera in the Main Passage group 16 from any point in the path, or the subject can continue moving towards Passage Left group 16. The operator 22 can view and select the neighboring logical camera group 16 using his control device 24. Selecting a camera 12, 14 from the neighboring camera group 16, e.g. Passage Left, will automatically switch to the selected camera's view and hand over control of this camera to the operator 22. If the selected camera is a PTZ camera 14, initially the view will be the view predefined in the logical camera group 16.

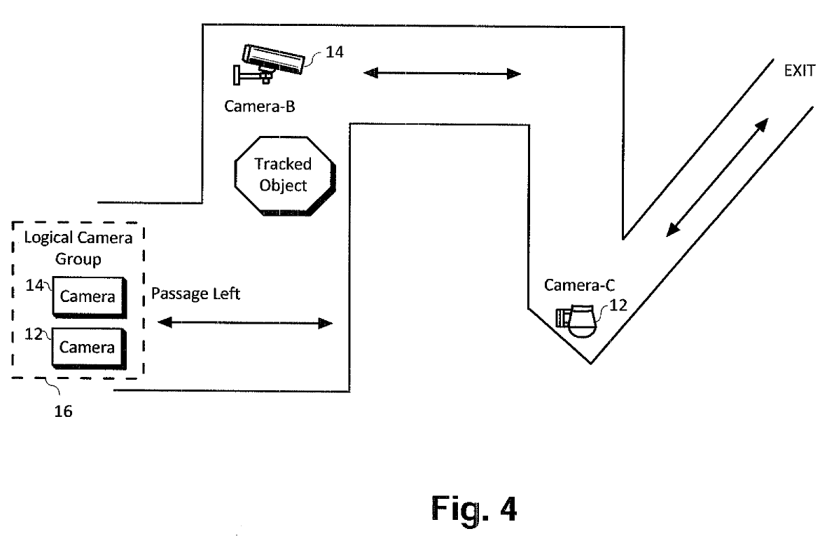

FIG. 4 shows an example of the inventive system 10 in which the area being monitored comprises a series of passages, some with sharp angles. As with the above configurations, each camera 12, 14 can be grouped with its neighboring cameras 12, 14, creating logical camera groups 16. As shown in FIG. 4, one logical camera group 16 can include both a fixed 12 and a PTZ 14 camera, shown in Passage Left. All of the cameras can be grouped into one logical camera group 16 (not shown). Another logical camera group 16 (not shown) can include camera-B 14 grouped with neighboring camera-C 12, and yet another group (not shown) can include camera-C 12 grouped with neighboring camera-B 14 including a common preset location for the PTZ camera-B 14.

The subject moving through Passage Left can turn and continue moving towards camera-B 14. Using the control device 24, the operator 22 can view and select the neighboring camera-B 14 and gain control of it. Selecting a camera 14 of the neighboring logical camera group 16, e.g. camera-B, will automatically switch to the selected camera's view and hand over its control to the operator 22. The subject moving through the view of camera-B 14 can continue moving towards camera-C 12 or move back in the direction of Passage Left. The control device 24 enables the operator 22 to have the option for viewing and controlling the neighboring cameras 12, 14 based on the logical camera groups 16.

The subject moving through the view of camera-C 12 can continue moving towards open EXIT, and away from camera-B 14 and camera-C 12, or the subject can move towards Passage Left. Regardless of the direction taken by the subject, the operator 22 can track the subject by monitoring the view and control of the neighboring cameras 12, 14.

In one embodiment, in a group 16 of two cameras, the control device 24 can directly switch between cameras. Further, when a group 16 contains multiple cameras, the operator 22 can be prompted to select the desired camera 12, 14.

The inventive system 10 also supports monitoring or tracking objects or subjects of interest among multiple operators 22. Hence, in an exemplary embodiment, when the subject being tracked leaves Area1, monitored by Operator 1 22, and enters Area2, monitored by Operator 2 22, Operator 1 22 can send a message and/or alert to Operator 2 22 using the control device 24. The message from Operator 1 22 could ask Operator 2 22 to commence monitoring of the subject of interest. If Area2 is monitored by more than one operator 22, all of these operators could be notified simultaneously. For example, if Operator 1 monitors a subject through camera-A 12, 14 in Area1 and the subject is about to travel in the direction of Area2, Operator 1 could alert Operators in Area2 using the control device 24. On acknowledgement from Operator 2, the selected camera, e.g. camera-B, will automatically be moved to a common preset location; Operator 2 is handed control of the selected camera, and this control is in accordance with Operator 2's operator privileges. Acknowledgement from Operator 2 can be a key press on Operator 2's control device 24.

A simple example of two operators, Operator A and Operator B, with three cameras each is now described. Operator A has access to Cameras 1, 2, and 3, and Operator B has access to Cameras 4, 5, and 6. Neither operator has access to the other's cameras. Operator A is tracking a subject at Camera1, and then to Camera2, and then to Camera3. Now, when the subject moves to an area monitored by Operator B, such as an area viewed by Camera4, Operator A sends the handover message and/or command to Operator B. Operator B receives the handover message and can start monitoring and controlling Camera4 to track the subject. Operator A can revert to monitoring and controlling of any one of his cameras, and can track another subject.

In another example, Operator A has access to Cameras 1, 2, 3 and Operator B has access to Cameras 3, 4, 5, 6, so that both operators have access to Camera3. The monitoring operation can proceed as discussed above, and an Operator Priority can be introduced within the system to decide on who takes the control over Camera3 in case of conflict. Operator A can notify e.g. send a message to, Operator B when the subject of interest is in the view of Camera3. Operator Priority is used to determine whether Operator A or Operator B can have control of Camera3. Further, if Operator A has a higher priority than Operator B, Operator A can take control of Camera3 from Operator B. Operator B, who has lower priority, can only obtain control of Camera3 if Operator A relinquishes control of it.

In one embodiment, the system 10 provides an option for setting Operator Priority from 1 to 99 where 1 is the highest and 99 is the lowest priority. In case of operators with the same priority levels, control over a camera 12, 14 will be based on first come, first serve. Also the second, non-controlling operator will receive a message on his keyboard 24 and/or monitor 18, 20 indicating the operator who is currently controlling the desired camera 12, 14. For example, in one embodiment, if Operator A is performing PTZ operations on Camera3 and Operator B is also looking at the view from Camera3 on his monitor, a message “Operator A controlling Camera3” appears on the monitor of Operator B. This feature of Operator Priority can be implemented using Honeywell International Inc.'s MaxPro (Switcher) system.

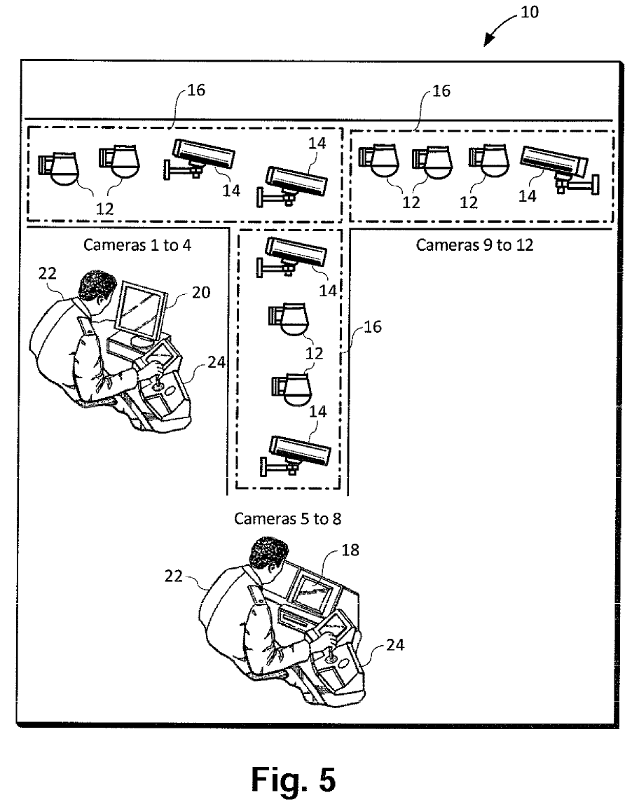

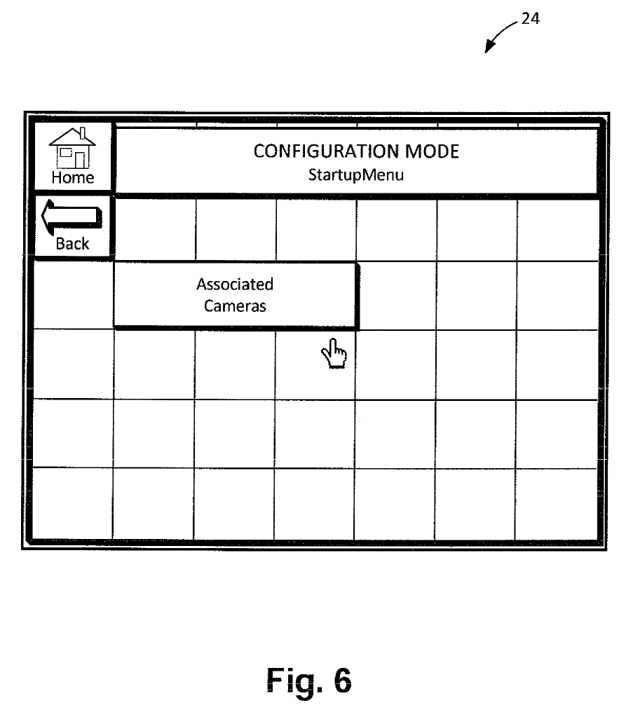

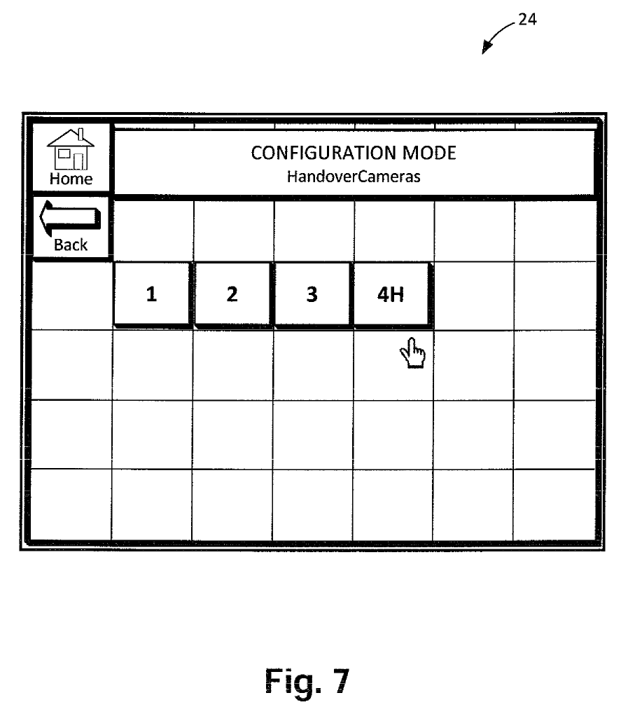

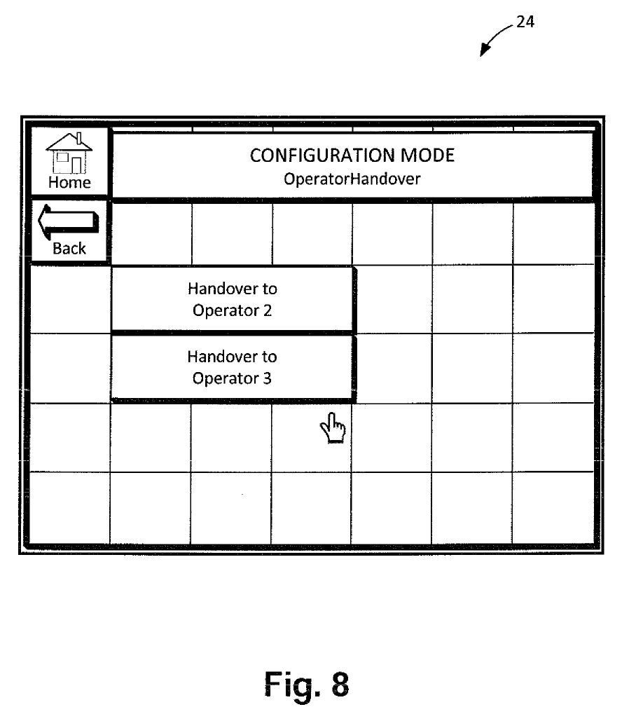

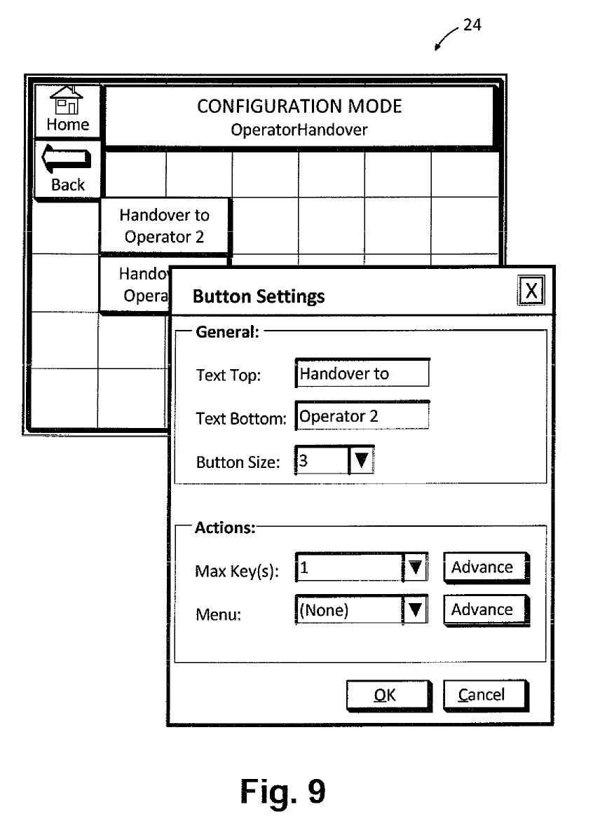

FIG. 5 shows an embodiment of the inventive system 10 having twelve cameras 12, 14 and multiple operators 22, two of whom are shown. FIGS. 6-9 show various control device display screens available to Operator 1 22 on his touch screen or control device 24. FIG. 6 shows an initial screen indicating the presence of logical control groups 16, e.g. Associated Cameras. If the Associated Cameras button is activated, e.g. clicked on, details, such as a list of all of the cameras in the group 16, are displayed. FIG. 7 shows such a display, listing cameras 1, 2, 3 and 4 in the group 16; camera4, shown as 4H, has handover capabilities. If the operator selects, e.g. clicks on, camera4, e.g. button “4H”, then the handover information for camera4 is displayed. FIG. 8 shows exemplary handover information for camera4, the information being “Handover to Operator 2” and “Handover to Operator 3”. FIG. 9 shows button setting information for the Handover to Operator 2 button.

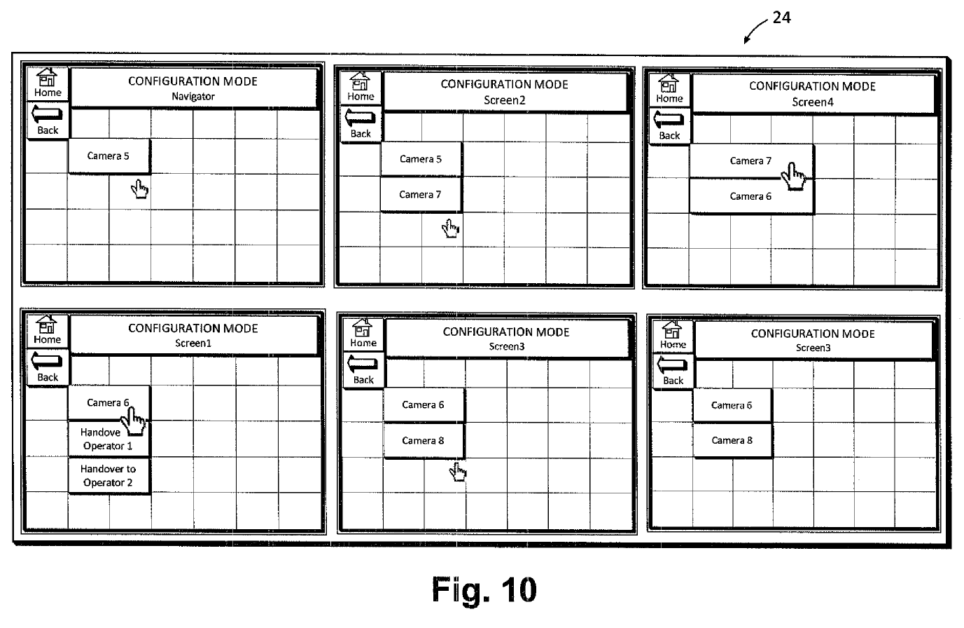

FIG. 10 illustrates various control device display screens available to Operator 3 22 based on the system configuration shown in FIG. 5. Six screens are shown in FIG. 10. The top left screen shows that camera5 is available to Operator 3. The top middle screen shows that camera6 is available with handover capabilities; camera6 can be handed over to either Operator 1 or Operator 2. The remaining screens show combinations of cameras (camera5 and camera7—top right; camera6 and camera8—bottom left and bottom right, and camera7 and camera6, bottom center).

FIG. 11 is a flow diagram of the operation of the inventive system 10. In step S1, logical camera groups 16 are created. In step S2, tracking and/or monitoring of a subject and/or object is performed. When an operator wants to change the camera 12, 14 he is using, (obtaining viewing data from) during tracking (S3=YES), the operator 22 activates the control device 24. Otherwise, tracking continues at step S2.

The next camera 12, 14 to be used or handed over is chosen in step S4. If the chosen camera 12, 14 is a handover camera (S5=YES), the operator selects an operator to receive the handover in step S5, and tracking continues at step S2. Otherwise (S5=NO), the chosen camera is activated and the operator 22 continues tracking at step S2.

Various aspects of the present disclosure may be embodied as a program, software, or computer instructions embodied in a computer or machine usable or readable medium, which causes the computer or machine to perform the steps of the method when executed on the computer, processor, and/or machine.

The security system can include a computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for video surveillance in a system having a plurality of cameras, comprising steps of:
creating a plurality of logical camera groups, each group comprising a list of at least one of the plurality of cameras;
tracking a subject using a current camera; and
changing from the current camera to a next camera using a control device,
wherein the control device provides the list of cameras in the logical camera group and the next camera is selected from the list.

2. The method according to claim 1, wherein each of the plurality of cameras is one of a fixed camera and a PTZ camera.

3. The method according to claim 2, wherein each PTZ camera has a preset view in the logical camera group.

4. The method according to claim 1, wherein the next camera is a handover camera enabling hand over from a current operator to a next operator.

5. The method according to claim 4, wherein the next operator is selected from a list of operators on the control device.

6. The method according to claim 1, further comprising a step of controlling the current camera based on operator priority.

7. A system for video surveillance, comprising:
a plurality of cameras;
a plurality of logical camera groups, each group comprising at least one of the plurality of cameras; and
a control device,
wherein a subject is tracked using a current camera in the logical group, the control device provides a list of cameras in the logical camera group and a next camera for tracking is selected from the list of cameras.

8. The system according to claim 7, wherein each of the plurality of cameras is one of a fixed camera and a PTZ camera.

9. The system according to claim 7, wherein each PTZ camera has a preset view in the logical camera group.

10. The system according to claim 7, wherein the next camera is a handover camera enabling hand over from a current operator to a next operator.

11. The system according to claim 10, wherein the next operator is selected from a list of operators on the control device.

12. The system according to claim 7, wherein control of the current camera is determined by operator priority.

13. A computer readable medium having computer readable program for operating on a computer for video surveillance in a system having a plurality of cameras, said program comprising instructions that cause the computer to perform steps of:
creating a plurality of logical camera groups, each group comprising a list of at least one of the plurality of cameras;
tracking a subject using a current camera; and
changing from the current camera to a next camera using a control device,
wherein the control device provides the list of cameras in the logical camera group and the next camera is selected from the list.

14. The computer readable medium according to claim 13, wherein each of the plurality of cameras is one of a fixed camera and a PTZ camera.

15. The computer readable medium according to claim 14, wherein each PTZ camera has a preset view in the logical camera group.

16. The computer readable medium according to claim 13, wherein the next camera is a handover camera enabling hand over from a current operator to a next operator.

17. The computer readable medium according to claim 16, wherein the next operator is selected from a list of operators on the control device.

18. The computer readable medium according to claim 13, further comprising a step of controlling the current camera based on operator priority.
